(19) United States
(12) Patent Application Publication
(10) Pub. No.: US 2005/0172924 A1
(43) Pub. Date: Aug. 11, 2005

(54) Air management systems

(76) Inventor: David N. Simon, Flagstaff, AZ (US)

Correspondence Address: STONEMAN LAW OFFICES, LTD, 3113 NORTH 3RD STREET, PHOENIX, AZ, 85012, US

(21) Appl. No.: 11/051,902

(22) Filed: Feb. 4, 2005

Related U.S. Application Data
(60) Provisional application No. 60/626,278, filed on Nov. 8, 2004.
(60) Provisional application No. 60/602,571, filed on Aug. 17, 2004.
(60) Provisional application No. 60/581,813, filed on Jun. 21, 2004.
(60) Provisional application No. 60/543,377, filed on Feb. 9, 2004.

(51) Int. Cl. F02M 35/10

(52) U.S. Cl. 123/184.23

(57) ABSTRACT

An air management system for improved airflow within a vehicle carburetor or fuel injection throttle-body. The air management system comprises a divider plate positioned within the airflow passage of the carburetor or fuel injection throttle body. Several embodiments utilize air pressure equalizing apertures for equalizing fluid pressures above and below the divider plate.

### CROSS-REFERENCES TO RELATED APPLICATIONS

The present application is a related to and claims priority from prior provisional application Ser. No. 60/626,278 filed Nov. 8, 2004, entitled “AIR MANAGEMENT SYSTEMS”, and from prior provisional application Ser. No. 60/602,571, filed Aug. 17, 2004, entitled “AIR MANAGEMENT SYSTEMS”, and from prior provisional application Ser. No. 60/581,813, filed Jun. 21, 2004, entitled “AIR MANAGEMENT SYSTEMS”, and from prior provisional application Ser. No. 60/543,377, filed Feb. 09, 2004, entitled “AIR MANAGEMENT SYSTEM”, the content of each of which are incorporated herein by this reference and are not admitted to be prior art with respect to the present invention by the mention in this cross-reference section.

### BACKGROUND

This invention relates to air management systems relating to improved airflow along an air-inlet conduit of an internal combustion engine fuel system. More particularly, this invention relates to improving airflow in an air-inlet conduit of a throttle body or carburetor that is opened and closed in proportion to user operation of a throttle control in a vehicle powered by an internal combustion engine.

Typically, in an internal combustion engine, a fuel delivery system delivers a proper mixture of combustible fuel and air to the engine. Fuel delivery systems include carburetors and fuel injection systems with throttle bodies. Both carburetors and fuel injection systems utilize an air-inlet system comprising at least one air inlet conduit having at least one means of air volume regulation. For example, carburetors and throttle bodies typically use a butterfly valve for air regulation in the air inlet conduit. Furthermore, some carburetors, such as side draft carburetors, may utilize a slide-type valve for air regulation (most common on motorcycles). The slide-type valve control slidably opens and closes in response to throttle commands by the vehicle operator.

One of the problems with such air-inlet systems is the turbulent air created when the throttles are less than full throttle; in that case, the air regulator reflects the majority of the air entering the air inlet conduit, causing turbulent air in the air inlet conduit and slowing the smooth transition of the air through the air regulator and into the engine. Typically, at low to medium throttle, there is a “hesitation” in the engine response from when the air regulator is opened to when the engine gets the proper fuel-air mixture to increase engine RPM (revolutions per minute).

Many attempts have been made to improve horsepower and fuel efficiency in internal combustion engines. An inexpensive device to provide consistent airflow through the air inlet conduit at low to medium throttle is needed and would improve performance and decrease “hesitation”.

### OBJECTS AND FEATURES OF THE INVENTION

A primary object and feature of the present invention is to overcome the above-mentioned problems and fulfill the above-mentioned needs.

Another object and feature of the present invention is to provide a system for providing more consistent airflow through the air inlet conduit of an internal combustion engine at low to medium throttle.

It is a further object and feature of the present invention to provide such a system to improve horsepower and fuel efficiency in internal combustion engines.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides an air management system relating to directing at least one flow of air passing through at least one air conduit of at least one vehicle fuel system, the at least one air conduit comprising at least one airflow inlet, at least one airflow outlet, and at least one airflow regulator adapted to regulate the passage of the at least one flow of air from the at least one airflow inlet, to the at least one airflow outlet, such system comprising: at least one airflow director to direct the at least one flow of air within the at least one air conduit; wherein such at least one airflow director comprises at least one fixed positioner to assist fixed positioning of such at least one airflow director in at least one geometric relationship with the at least one air conduit; wherein such at least one airflow director further comprises at least one divider adapted to divide at least one portion of the at least one air conduit into at least one first airflow channel and at least one second airflow channel; wherein such at least one airflow director further comprises at least one air pressure equalizer adapted to assist air pressure equalizing between the at least one first airflow channel and the at least one second airflow channel. Moreover, it provides such an air management system wherein such at least one fixed positioner is adapted to be removably retained within the at least one portion of the at least one air conduit. Additionally, it provides such an air management system wherein such at least one fixed positioner is adapted to be removably retained adjacent the at least one portion of the at least one air conduit.

Also, it provides such an air management system wherein: the at least one air conduit comprises at least one interior peripheral profile; and such at least one fixed positioner comprises at least one peripheral profile substantially matching such at least one interior peripheral profile of the at least one air conduit. In addition, it provides such an air management system wherein: the at least one airflow regulator is disposed within the at least one air conduit between the at least one airflow inlet and the at least one airflow outlet; and such at least one fixed positioner is adapted to be removably retained substantially within the at least one air conduit between the at least one airflow inlet and the at least one airflow regulator. And, it provides such an air management system wherein: the at least one airflow regulator is disposed within the at least one air conduit between the at least one airflow inlet and the at least one airflow outlet; and such at least one fixed positioner is adapted to be removably retained substantially within the at least one air conduit between the at least one airflow regulator and the at least one airflow outlet. Further, it provides such an air management system wherein: such at least one fixed positioner is adapted to be removably mounted adjacent the at least one airflow inlet. Even further, it provides such an air management system wherein: such at least one fixed positioner is adapted to be removably mounted adjacent the at least one airflow outlet.

Moreover, it provides such an air management system wherein, within the at least one portion, the at least one first airflow channel and the at least one second airflow channel comprise essentially equal volumes. Additionally, it provides such an air management system wherein, within the at least one portion, the at least one first airflow channel and the at least one second airflow channel comprise unequal volumes. Also, it provides such an air management system wherein such unequal volumes comprise at least one volumetric relationship having a ratio of about three to one. In addition, it provides such an air management system further comprising such at least one vehicle fuel system.

In addition, it provides such an air management system wherein such at least one divider comprises such at least one air pressure equalizer. Further, it provides such an air management system wherein such at least one air pressure equalizer comprises at least one aperture adapted to provide fluid communication between the at least one first airflow channel and the at least one second airflow channel. Even further, it provides such an air management system wherein such at least one aperture comprises at least one essentially round hole. Moreover, it provides such an air management system wherein such at least at least one essentially round hole has a diameter of between about one-sixteenth inch and about one-inch.

In accordance with another preferred embodiment hereof, this invention provides an air management system relating to directing at least one flow of air passing through at least one air conduit of at least one vehicle fuel system, the at least one air conduit comprising at least one airflow inlet, at least one airflow outlet, and at least one airflow regulator adapted to regulate the passage of the at least one flow of air from the at least one airflow inlet, to the at least one airflow outlet, such system comprising: at least one airflow director to direct the at least one flow of air within the at least one air conduit; wherein such at least one airflow director comprises at least one fixed positioner to assist fixed positioning of such at least one airflow director in at least one geometric relationship with the at least one air conduit; wherein such at least one airflow director further comprises at least one divider adapted to divide at least one portion of the at least one air conduit into at least one first airflow channel and at least one second airflow channel; and wherein such at least one fixed positioner is adapted to be removably retained adjacent the at least one airflow outlet. Additionally, it provides such an air management system wherein such at least one fixed positioner is adapted to be removably retained substantially within the at least one air conduit between the at least one airflow regulator and the at least one airflow outlet.

In addition, it provides such an air management system wherein: the at least one air conduit comprises at least one interior peripheral profile; and such at least one fixed positioner comprises at least one peripheral profile substantially matching such at least one interior peripheral profile of the at least one air conduit. In addition, it provides such an air management system further comprising: at least one second airflow director to direct the at least one flow of air within the at least one air conduit; wherein such at least one second airflow director comprises at least one second fixed positioner to assist fixed positioning of such at least one second airflow director in at least one geometric relationship with the at least one air conduit; wherein such at least one second airflow director further comprises at least one second divider adapted to divide at least one second portion of the at least one air conduit into at least one third airflow channel and at least one fourth airflow channel; and wherein such at least one second fixed positioner is further adapted to be removably retained adjacent the at least one airflow inlet. And, it provides such an air management system wherein, such at least one second airflow director is adapted to be removably retained within the at least one air conduit between the at least one airflow inlet and the at least one airflow regulator. Further, it provides such an air management system wherein, within the at least one second portion, the at least one third airflow channel and the at least one fourth airflow channel comprise essentially equal volumes. Even further, it provides such an air management system wherein, within the at least one second portion, the at least one third airflow channel and the at least one fourth airflow channel comprise unequal volumes. Moreover, it provides such an air management system wherein such unequal volumes comprise at least one volumetric relationship having a ratio of about three to one.

Additionally, it provides such an air management system further comprising the at least one vehicle fuel system. Also, it provides such an air management system further comprising the at least one vehicle fuel system. In addition, it provides such an air management system wherein at least one of such at least one divider and at least one second divider comprise at least one air pressure equalizer. In addition, it provides such an air management system wherein such at least one air pressure equalizer comprises at least one aperture. Further, it provides such an air management system wherein such at least one aperture comprises at least one essentially round hole. Even further, it provides such an air management system wherein such at least at least one essentially round hole has a diameter of between about one-sixteenth inch and about one-inch.

In accordance with another preferred embodiment hereof, this invention provides an air management system relating to directing at least one flow of air passing through at least one air conduit of at least one vehicle fuel system, the at least one air conduit comprising at least one airflow inlet, at least one airflow outlet, and at least one airflow regulator adapted to regulate the passage of the at least one flow of air from the at least one airflow inlet, to the at least one airflow outlet, such system comprising: at least one airflow director to direct the at least one flow of air within the at least one air conduit; wherein such at least one airflow director comprises at least one fixed positioner to assist fixed positioning of such at least one airflow director in at least one geometric relationship with the at least one air conduit; wherein such at least one airflow director further comprises at least one divider adapted to divide at least one portion of the at least one air conduit into at least one first airflow channel and at least one second airflow channel; and wherein at least one divider portion of such at least one divider is located substantially outside of exactly one single plane. Even further, it provides such an air management system wherein such at least one divider portion comprises at least one arc. Even further, it provides such an air management system wherein: the at least one airflow regulator comprises at least one throttle slide having at least one cutaway; and such at least one arc is structured and arranged to assist improved air flow adjacent the at least one cutaway. Even further, it provides such an air management system wherein such at least one arc substantially matches in profile such at least one cutaway of such at least one throttle slide of the at least one vehicle fuel system. Even further, it provides such an air management system wherein such at least one airflow director comprises at least one air pressure equalizer adapted to assist air pressure equalizing between the at least one first airflow channel and the at least one second airflow channel. Even further, it provides such an air management system wherein: the at least one air conduit comprises at least one interior peripheral profile; and such at least one fixed positioner comprises at least one peripheral profile substantially matching such at least one interior peripheral profile of the at least one air conduit.

### BRIEF DESCRIPTION OF THE DRAWINGS

FIG. 1 shows a perspective view of a motorcycle carburetor comprising an air inlet conduit and slide-type air regulator.

FIG. 2 shows a perspective view of an airflow divider assembly of the air management system according to a preferred embodiment of the present invention.

FIG. 3 shows a perspective view of the airflow divider assembly of FIG. 2 adjacent the motorcycle carburetor air conduit of FIG. 1 according to a preferred embodiment of the present invention.

FIG. 4 shows a perspective view of the airflow divider assembly of FIG. 3 installed within the motorcycle carburetor air conduit.

FIG. 5 shows a diagrammatic representation of the air inlet conduit of the slide-type air regulator of FIG. 1 at low throttle.

FIG. 6 shows a diagrammatic representation of the air inlet conduit of the slide-type air regulator of FIG. 3 with the air management system installed.

FIG. 7 shows a perspective view of the airflow divider assembly of FIG. 3.

FIG. 8 shows a front view of the airflow divider assembly of FIG. 3.

FIG. 9 shows a side perspective view of the airflow divider assembly of FIG. 3.

FIG. 9a shows a sectional view through the section 9a-9a of FIG. 9.

FIG. 10 shows a perspective view of a fuel-injector-style throttle-body having an air conduit and butterfly-valve-type air regulator.

FIG. 11 shows a perspective view of another airflow divider assembly of the air management system according to another preferred embodiment of the present invention.

FIG. 12 shows a perspective view of the airflow divider assembly of FIG. 11 installed in the throttle body air conduit of FIG. 10 according to another preferred embodiment of the present invention.

FIG. 13 shows a diagrammatic representation of the air conduit and air regulator (butterfly valve) of FIG. 10 in a low throttle position.

FIG. 14 shows a diagrammatic representation of the air inlet conduit and air regulator (butterfly valve) of FIG. 10 in a medium throttle position.

FIG. 15 shows a diagrammatic representation of an air inlet conduit and butterfly valve in a low throttle position with the airflow divider assembly of the air management system installed according to a preferred embodiment of FIG. 12.

FIG. 16 shows a diagrammatic representation of an air inlet conduit and butterfly valve in a medium throttle position with the airflow divider assembly of the air management system installed according to a preferred embodiment of FIG. 12.

FIG. 17 shows a perspective view of another airflow divider assembly of the air management system according to another preferred embodiment of the present invention.

FIG. 18 shows a sectional view diagrammatically illustrating the air inlet conduit of the slide-type air regulator of FIG. 6 at low throttle.

FIG. 19 shows a sectional view diagrammatically illustrating the air inlet conduit of the slide-type air regulator, at low throttle, utilizing a pair of air management systems, according to another preferred embodiment of the present invention.

FIG. 20 shows a sectional view diagrammatically illustrating the air inlet conduit of the slide-type air regulator, at low throttle, utilizing a pair of air management systems, according to another preferred embodiment of the present invention.

FIG. 21 shows a diagrammatic representation of the air inlet conduit and butterfly valve air regulator in a low throttle position, with the airflow divider assembly of the air management system installed according to the preferred embodiment of FIG. 12.

FIG. 22 shows a diagrammatic representation of the air inlet conduit and butterfly valve air regulator, with the airflow divider assembly of the air management system installed according to the preferred embodiment of FIG. 12, and an additional posterior airflow divider assembly installed downstream of the butterfly valve air regulator, according to another preferred embodiment of the present invention.

FIG. 23 shows a perspective view of an aperture containing posterior air management system according to the preferred embodiment of FIG. 22.

FIG. 24 shows a perspective view of another posterior air management system according to a preferred embodiment of the present invention.

FIG. 25 shows a sectional view diagrammatically illustrating the air inlet conduit of the carburetor of FIG. 1 at low throttle.

FIG. 26 shows a sectional view diagrammatically illustrating the air inlet conduit of the carburetor, at low throttle, utilizing a posterior air management system, according to the preferred embodiments of FIG. 23 and FIG. 24.

FIG. 27 shows a sectional view diagrammatically illustrating the air inlet conduit of the carburetor, at low throttle, utilizing a posterior air management system, according to another preferred embodiment of the present invention.

FIG. 28 shows a diagrammatic representation of the air inlet conduit and butterfly valve air regulator in a low throttle position.

FIG. 29 shows a diagrammatic representation of the air inlet conduit and butterfly valve air regulator, with a posterior airflow divider assembly installed downstream of the butterfly valve air regulator, according to another preferred embodiment of the present invention.

FIG. 30 shows a diagrammatic representation of the air inlet conduit and butterfly valve air regulator, with an aperture containing posterior airflow divider assembly installed downstream of the butterfly valve air regulator, according to another preferred embodiment of the present invention.

FIG. 31 shows a perspective view of a downstream posterior airflow divider assembly adjacent the throttle body inlet air conduit of FIG. 10 and used in conjunction with an upstream air management system according to another preferred embodiment of the present invention.

FIG. 32a shows a perspective view of the downstream posterior airflow divider assembly of FIG. 32a.

FIG. 32b shows a sectional view through the section 32c-32c of FIG. 32a.

FIG. 33 shows a perspective view of a shaped airflow divider assembly of the air management system according to a preferred embodiment of the present invention.

FIG. 34 shows an intake-end view of the shaped airflow divider assembly of FIG. 33.

FIG. 35 shows a sectional view through the section 35-35 of FIG. 33.

FIG. 36 shows an intake end view of a shaped airflow divider assembly according to another preferred embodiment of the invention.

### DETAILED DESCRIPTION OF THE BEST MODES AND PREFERRED EMBODIMENTS OF THE INVENTION

The following detailed description will be accomplished by reference to preferred embodiments and will include Applicant's current best understanding of the theory of operation of the preferred embodiments. However, Applicant does not regard itself as bound, or the invention limited, by any particular theory of operation expressed herein, as some uncertainties exist, even in the underlying science itself.

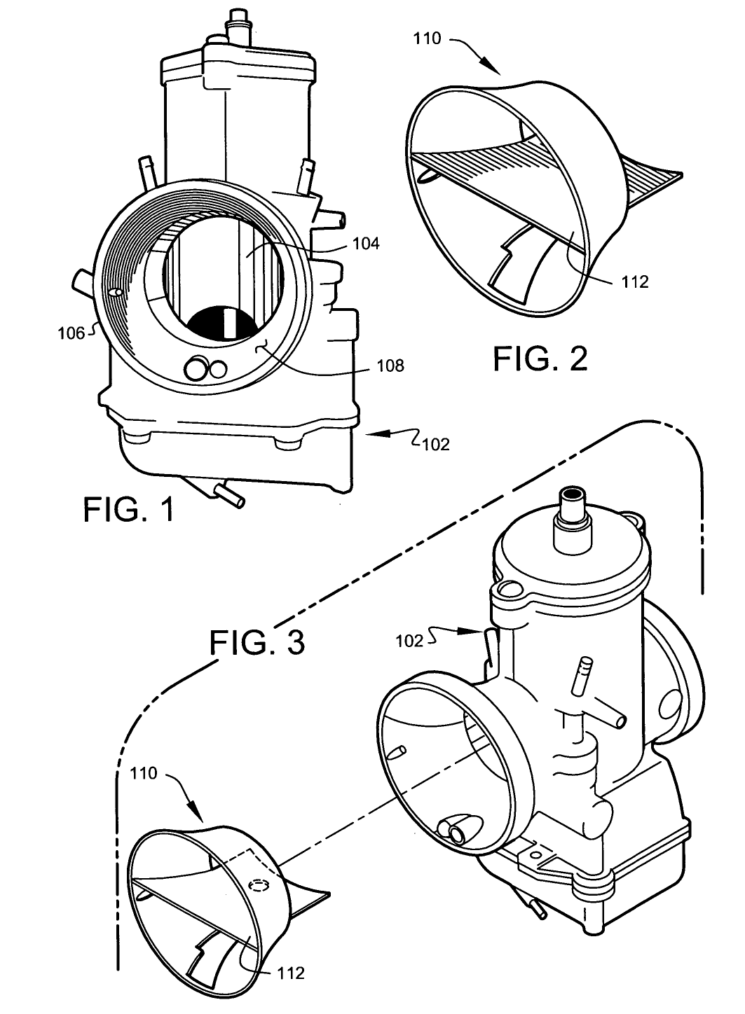

FIG. 1 shows a perspective view of a motorcycle carburetor 102 having an air inlet conduit 106 and slide-type air regulator 104 (at least embodying herein at least one airflow regulator). Typically, slide-type carburetors, such as carburetor 102, are used on motorcycles and all-terrain-vehicles (herein after referred to as ATV's). Although somewhat less common today, slide-type carburetors are also used within automobile, aircraft, and watercraft applications.

Inlet conduit 106 functions as a passage for transferring air through carburetor 102 into an internal combustion engine of the vehicle in which the carburetor is installed. Typically, air inlet conduit 106 comprises a venturi-shaped opening 108, as shown. Typically, opening 108 reduces slightly in diameter (sloping) as it leads inward toward air regulator 104, as shown. The structural shape of opening 108 assists the air flow and air speed into the fuel mixing chamber and takes advantage of the Bernoulli Effect (essentially, that the pressure is lower in a moving fluid than in a stationary fluid), as shown. The Bernoulli effect is used in carburetors to assist in drawing fuel from a fuel source and in mixing the fuel. Upon reading the teachings of this specification, those with ordinary skill in the art will now understand that, under appropriate circumstances, considering such issues as economics, user preference, fuel delivery system, etc., other shapes, sizes and diameters of the air inlet conduit, such as a straight throat air-inlet conduit, etc., may suffice.

FIG. 2 shows a perspective view of an airflow divider assembly 110 of air management system 100 according to a preferred embodiment of the present invention. FIG. 3 shows a perspective view of the airflow divider assembly 110 of FIG. 2 adjacent the motorcycle carburetor air inlet conduit 106 of FIG. 1. Preferably, air management system 100 comprises an airflow divider assembly 110 (at least embodying herein at least one airflow director to direct the at least one flow of air within the at least one air conduit) that inserts into air inlet conduit 106 above (upstream of) air regulator 104 (in this embodiment, the slide valve), as shown. Preferably, airflow divider assembly 110 is removably mounted within air inlet conduit 106, as shown.

Preferably, airflow divider assembly 110 comprises divider 112, preferably substantially flat, preferably mounted perpendicular to the opening of air regulator 104, as shown. Preferably, divider 112 is centered and spans the full diameter of opening 108, as shown. Preferably, divider 112 divides air inlet conduit 106 into two distinct chambers 114 and 116 to assist directing the airflow, as shown (at least embodying herein at least one divider adapted to divide at least one portion of the at least one air conduit into at least one first airflow channel and at least one second airflow channel). Most preferably, in use with slide-valve air regulator 104, divider 112 divides chamber 114 and chamber 116 into two airflow passages comprising essentially equal volumes, as shown. Upon reading the teachings of this specification, those with ordinary skill in the art will now understand that, under appropriate circumstances, considering such issues as economics, user preference, air inlet opening shape, air regulator (i.e. butterfly valve, sliding valve), etc., other placement locations for divider 112, such as offset from center, slightly angled, etc., may suffice.

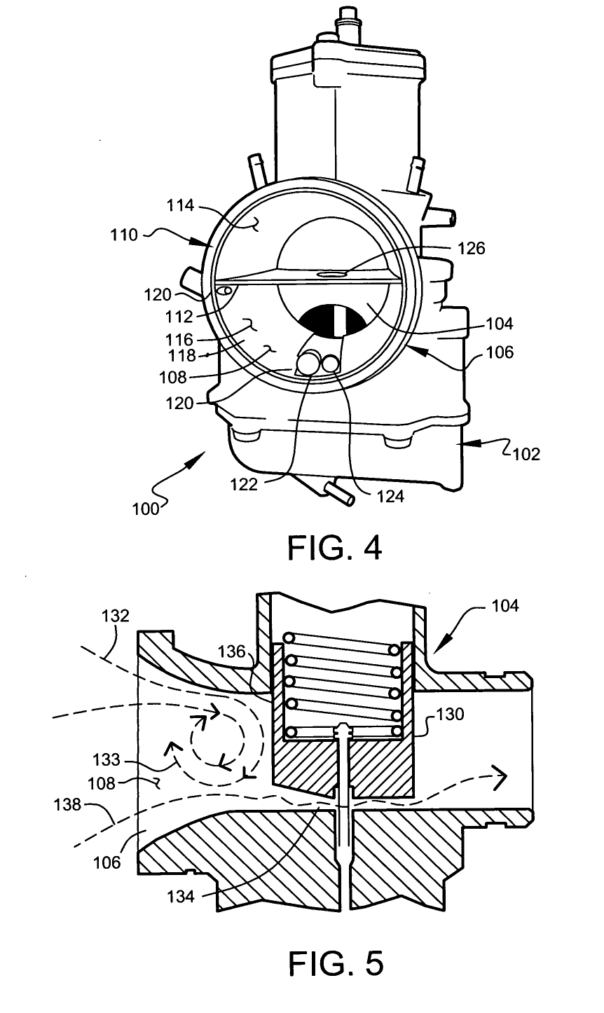

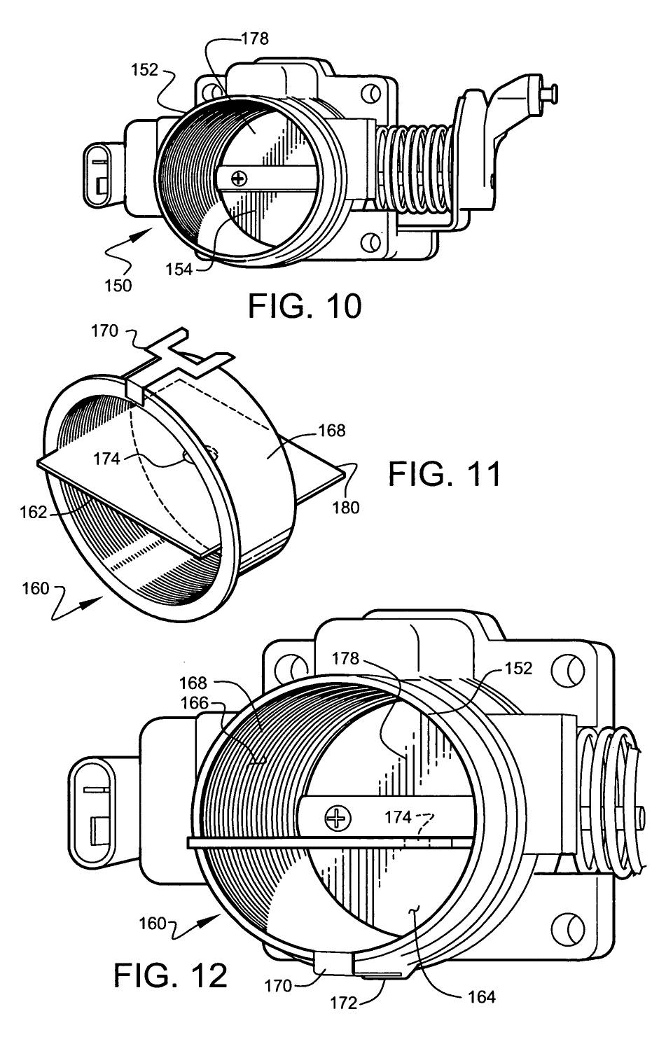

FIG. 4 shows a perspective view of airflow divider assembly 110 installed within the motorcycle carburetor air conduit of FIG. 3. FIG. 7 shows a perspective view of the airflow divider assembly 110 of FIG. 2 and FIG. 3. FIG. 8 shows a front view of the airflow divider assembly 110 of FIG. 7. FIG. 9 shows a side view of the airflow divider assembly 110 of FIG. 3. Preferably, the airflow divider assembly 110 comprises integral divider 112 and divider supporter 118, preferably formed to fit adjacent and closely match the interior profile of air inlet conduit 106, as shown (at least embodying herein wherein such at least one fixed positioner comprises at least one peripheral profile substantially matching such at least one interior peripheral profile of the at least one air conduit). In the present example, divider supporter 118 (at least embodying herein wherein such at least one airflow director comprises at least one fixed positioner to assist fixed positioning of such at least one airflow director in at least one geometric relationship with the at least one air conduit) is just slightly smaller than the inner diameter of the air inlet conduit 106, as shown. Preferably, airflow divider assembly 110 further comprises notches or form-fitting apertures 120 that removably fit over operable portions of air inlet conduit 106, such as fuel tube 122 and air breather 124 of carburetor 102. Preferably, divider supporter 118 positions divider 112 in a fixed geometric relationship with air inlet conduit 106, as shown (at least embodying herein wherein such at least one airflow director comprises at least one fixed positioner to assist fixed positioning of such at least one airflow director in at least one geometric relationship with the at least one air conduit). Notches preferably assist in proper positioning of airflow divider assembly 110 within air inlet conduit 106, as shown. Upon reading the teachings of this specification, those with ordinary skill in the art will now understand that, under appropriate circumstances, considering such issues as economics, user preference, etc., other fixed positioning arrangements, such as positioning pins, mechanical fasteners, etc., may suffice.

Preferably, divider 112 comprises air pressure equalizing aperture 126 (at least embodying herein at least one air pressure equalizer adapted to assist air pressure equalizing between the at least one first airflow channel and the at least one second airflow channel), preferably a round hole, preferably having a diameter of between about one-sixteenth inch and about one-inch, preferably about one-quarter inch in diameter for the illustrated air conduit (within a Mikuni 38 mm slide-carburetor). Preferably, a range of fuel-mixing arrangements may use selected-sized aperture 126. Upon reading the teachings of this specification, those with ordinary skill in the art will now understand that, under appropriate circumstances, considering such issues as economics, user preference, preferred specific requirements of the user, etc., other sized apertures, such as larger or smaller, etc., may suffice.

Preferably, the center of aperture 126 is about six-tenths of an inch from bottom 128 of divider 112, as shown. Upon reading the teachings of this specification, those with ordinary skill in the art will now understand that, under appropriate circumstances, considering such issues as economics, user preference, aperture size, etc., other positional dimensions for aperture 126, such as closer or farther from the divider 112, etc., may suffice.

Preferably, bottom 128 of divider 112 comprises a concave radius very closely matching the convex radius the adjacent slide valve 130 (at least embodying herein at least one airflow regulator) of the air regulator 104, as shown. Preferably, the gap between bottom 128 and slide valve 130 is very close, preferably less than about sixty-thousandths of an inch however; the gap between bottom 128 and slide valve 130 is preferably sized to prevent all physical contact between bottom 128 and slide valve 130 during vehicle operation. Preferably, aperture 126 provides additional airflow to be drawn into opening 108, as shown. Further, the air is drawn through aperture 126 from the pressure differential on either side of divider 112 (typically the higher flow side, having lower pressure, will draw air from the lower flow side, having higher pressure). Upon reading the teachings of this specification, those with ordinary skill in the art will now understand that, under appropriate circumstances, considering such issues as economics, user preference, air conduit size, etc., other aperture arrangements, such as multiple apertures, no apertures, larger or smaller apertures, slotted apertures, etc., may suffice.

FIG. 5 illustrates the slide-type carburetor of FIG. 1 without airflow divider assembly 110 installed. FIG. 5 shows a diagrammatic representation of air inlet conduit 106 of slide-type air regulator 104 of FIG. 1 at low throttle. Typically, air 132 entering air inlet conduit 106 is partially blocked by slide valve 130, as shown. Typically, the incoming charge of air 132 blocked by slide valve 130, forms a region of turbulent air 133, above opening 134, as shown. Typically, as slide valve 130 opens in response to an increased throttle, an increasing volume of air 132 is reflected back into the upstream portion of air inlet conduit 106, toward opening 108, as shown. This reflected air generates significant fluid turbulence above opening 134 resulting in a disruption of free-flowing air 138 through opening 134, as shown.

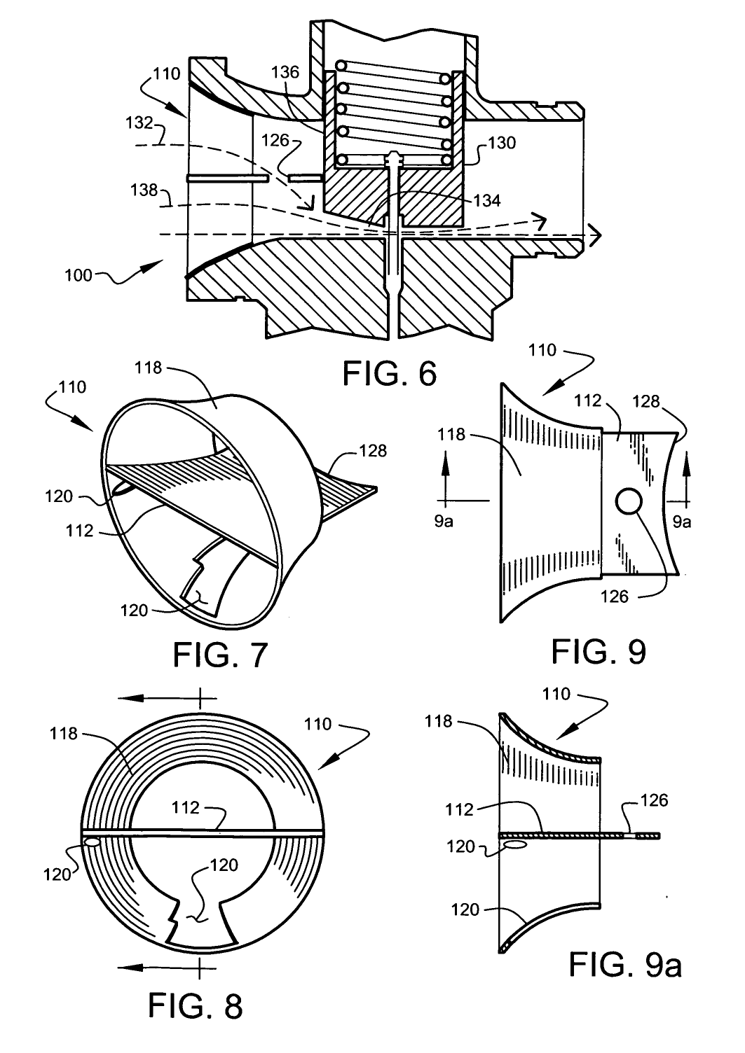

FIG. 6 shows a diagrammatic representation of air inlet conduit 106 of slide-type air regulator 104 of FIG. 3 with the air management system 100 installed upstream of the slide-type air regulator 104. Preferably, the placement of airflow divider assembly 110 and associated divider 112 within air inlet conduit 106, directs air 132 such that there is little or no turbulent air 133 entering through opening 134, as shown. Further, the free-flowing air 138 is preferably drawn through the opening 134 more quickly, enabling a more consistent airflow through the opening 134. As stated above, divider 112 preferably comprises aperture 126, preferably round, preferably about one-quarter inch in diameter within a preferred range of about one-sixteenth-inch diameter to about one-half-inch in diameter, preferably centered about six-tenths of an inch from slide valve face 136 of air regulator 104 (in this example, the slide valve 130). Preferably, aperture 126 provides additional airflow to be drawn into the opening 134, in a controlled manner, as shown. Further, air 132 is drawn through aperture 126 from the pressure differential on either side of divider 112 (typically the higher flow side will draw air from the lower flow side). Upon reading the teachings of this specification, those with ordinary skill in the art will now understand that, under appropriate circumstances, considering such issues as economics, user preference, air conduit size, etc., other aperture arrangements, such as multiple apertures, larger or smaller apertures, etc., may suffice.

FIG. 9a shows a sectional view through the section 9a-9a airflow divider assembly 110 of FIG. 9. Preferably, divider supporter 118 comprises a substantially rigid material such as metal. Preferably, divider 112 also comprises a substantially rigid material, preferably matching the material selected for divider supporter 118. Preferably, divider 112 is permanently joined to divider supporter 118. Preferably, divider 112 is permanently joined to divider supporter 118 by welding, brazing or press-fit. Upon reading the teachings of this specification, those with ordinary skill in the art will now understand that, under appropriate circumstances, considering issues such as, intended use, cost, etc., other construction arrangements, such as, for example, unitary polymer casting, billet milling, use of two or more materials, etc., may suffice.

FIG. 10 shows a perspective view of fuel-injector-style throttle-body 150 having air inlet conduit 152 and butterfly-valve air regulator 154. Fuel-injector-style throttle-body 150 is used here to represent a typical automotive style fuel-air mixing assembly. Such fuel-air mixing assemblies comprise an air inlet conduit 152 and air regulator, most typically a butterfly-valve air regulator 154 (at least embodying herein at least one airflow regulator), as shown. Typically, air inlet conduit 152 has a uniform conduit (straight throat, not sloped like a venturi) as shown. With fuel injection, fuel is typically injected into the intake manifold directly adjacent to the intake valves or at a point within the upstream air mixture.

FIG. 11 shows a perspective view of another airflow divider assembly 160 of air management system 100 according to another preferred embodiment of the present invention. FIG. 12 shows a perspective view of the airflow divider assembly of FIG. 11 installed in the throttle body inlet air conduit 152 of FIG. 10.

Preferably, airflow divider assembly 160 (at least embodying herein at least one airflow director to direct the at least one flow of air within the at least one air conduit) of air management system 100 is adapted to fit upstream of such a butterfly-valve air regulator 154 installed within throttle body 150. Preferably, airflow divider assembly 160 inserts into air inlet conduit 152 above (upstream of) butterfly-valve air regulator 154, as shown. Preferably, airflow divider assembly 160 is removably mounted within air inlet conduit 152, as shown. Preferably, airflow divider assembly 160 comprises divider 162, preferably substantially flat, preferably mounted perpendicular to the longitudinal axis of air inlet conduit 152, preferably centered and spanning the full diameter of the air inlet conduit 152, as shown. Preferably, divider 162 divides air inlet conduit 152 into two distinct airflow passages, chamber 164 and chamber 166, as shown (at least embodying herein at least one divider adapted to divide at least one portion of the at least one air conduit into at least one first airflow channel and at least one second airflow channel). Preferably, airflow divider assembly 160 has a relatively straight body portion 168 adapted to match and be just slightly less in diameter to the throttle body inner diameter, as shown. Upon reading the teachings of this specification, those with ordinary skill in the art will now understand that, under appropriate circumstances, considering such issues as economics, user preference, air inlet opening shape, air regulator (i.e. butterfly valve), etc., other placement locations for a divider, such as offset from center, slightly angled, etc., may suffice. Preferably, straight body portion 168 positions divider 162 in a fixed geometric relationship with air inlet conduit 152, as shown (at least embodying herein wherein such at least one airflow director comprises at least one fixed positioner to assist fixed positioning of such at least one airflow director in at least one geometric relationship with the at least one air conduit).

Preferably, airflow divider assembly 160 comprises mounting tab 170, preferably attached to a fixed point on airflow divider assembly 160, preferably weldably attached, as shown. Preferably, mounting tab 170 is used to fixably mount the airflow divider assembly 160 to the air inlet conduit 152, as shown. Preferably, the mounting tab slides over exterior 172 of the air inlet conduit 152 such that the airflow divider assembly may be removed, as shown. Upon reading the teachings of this specification, those with ordinary skill in the art will now understand that, under appropriate circumstances, considering such issues as economics, user preference, etc., other methods of fixing an airflow divider assembly to an air inlet conduit, such as, mechanical fastening, bonding, clamping, etc., may suffice.

Preferably, divider 162 comprises aperture 174 (at least embodying herein at least one air pressure equalizer adapted to assist air pressure equalizing between the at least one first airflow channel and the at least one second airflow channel), preferably round, preferably about one-quarter inch in diameter and preferably within the aforesaid diameter range. Preferably, the center of the aperture 174 is about six-tenths of an inch from the face 178 of the air regulator 154. Preferably, bottom 180 of divider 162 is, when installed, positioned closely adjacent air regulator 154, in this example a butterfly valve, as shown. Preferably, the installed gap between bottom 180 of divider 162 and butterfly valve air regulator 154 is about four-tenths of an inch (larger than in the slide valve since the butterfly valve opens in both directions). Preferably, aperture 174 provides additional airflow to be drawn into the most open of chamber 164 or chamber 166 during operation of the air regulator in response to throttle commands by a user. Further, the air is preferably drawn through aperture 174 from the pressure differential on either side of divider 162 (typically the higher flow side will draw air from the lower flow side). Upon reading the teachings of this specification, those with ordinary skill in the art will now understand that, under appropriate circumstances, considering such issues as economics, user preference, air conduit size, etc., other aperture arrangements, such as multiple apertures, no apertures, larger or smaller apertures, etc., may suffice.

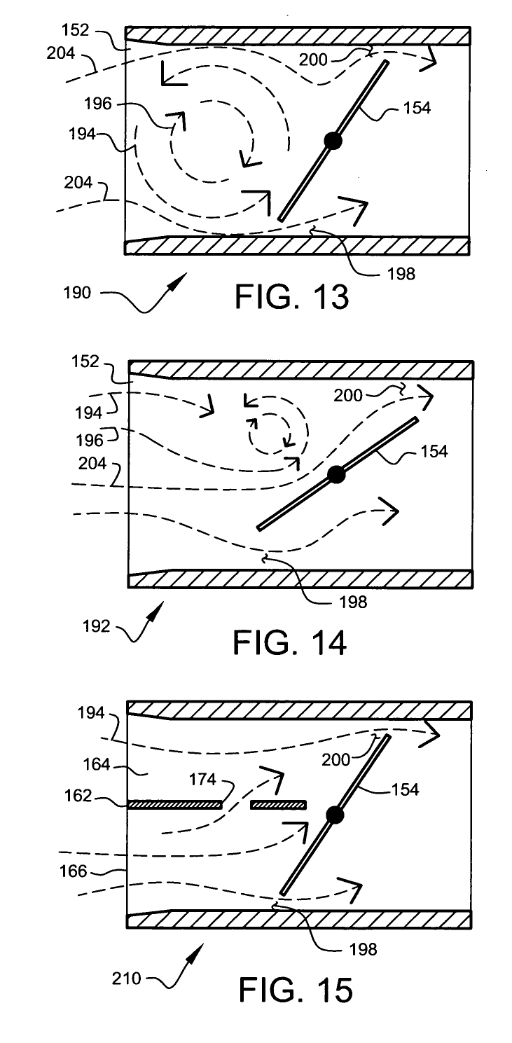

FIG. 13 shows a diagrammatic representation of the prior art air inlet conduit 152 and butterfly valve air regulator 154 of FIG. 10 in a low throttle position 190. FIG. 14 shows a diagrammatic representation of the prior art air inlet conduit 152 and butterfly valve air regulator 154 of FIG. 10 in a medium throttle position 192.

In the illustration of FIG. 13 and FIG. 14, air 194 entering air inlet conduit 152 utilizing butterfly valve 154 is shown as air 194 is blocked by butterfly valve 154. As the upstream flow of air 194 impacts butterfly valve air regulator 154, it forms regions of turbulent air 196, as shown. As butterfly valve air regulator 154 opens in response to an increased throttle, some of air 194 flows through opening 198 and opening 200 or is deflected into opening 200 by butterfly valve face 202, as shown. The balance of air 194 is reflected back into air inlet conduit 152, as shown. The reflected air causes turbulence and a disruption of free-flowing air 204 through butterfly valve air regulator 154, as shown. The blocked air causes a momentary loss of flow when the throttle is opened and therefore a momentary loss in power response.

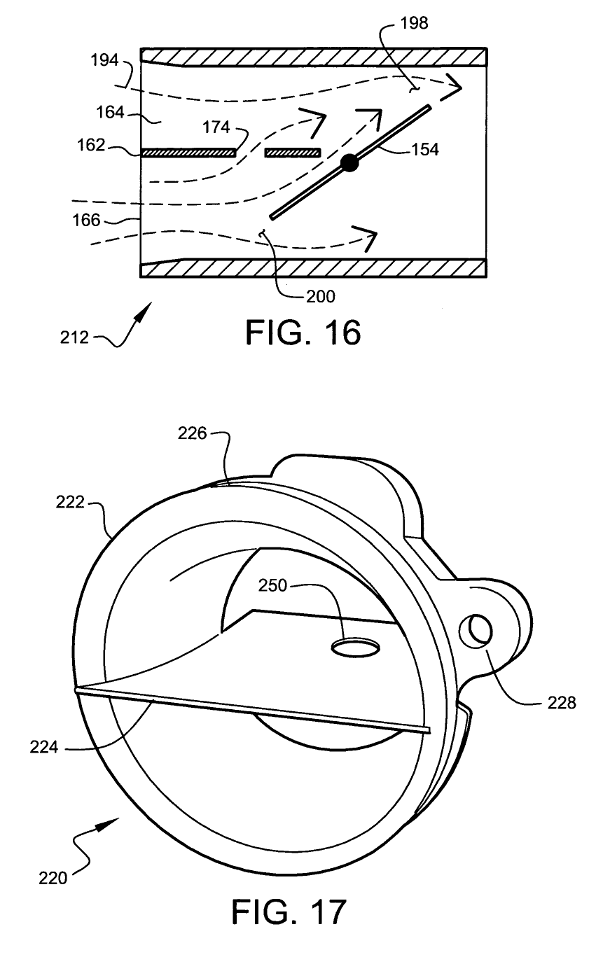

FIG. 15 shows a diagrammatic representation of air inlet conduit 152 and butterfly valve air regulator 154 in a low throttle position 210 with airflow divider assembly 160 of air management system 100, installed upstream of butterfly valve air regulator 154. FIG. 16 shows a diagrammatic representation of air inlet conduit 152 and butterfly valve air regulator 154 in medium throttle position 212 with airflow divider assembly 160 of air management system 100 installed upstream of butterfly valve air regulator 154.

FIG. 15 and FIG. 16 illustrate the improved airflow within air inlet conduit 152 of a throttle body utilizing a butterfly valve air regulator 154. Preferably, placement of airflow divider assembly 160 and associated divider 162 directs air 194 such that there is little or no turbulent air 196 entering through opening 198 and opening 200, as shown. Further, air 194 is preferably drawn through opening 198 and opening 200 more quickly, enabling a more consistent airflow through opening 198 and opening 200 and therefore a quicker response of power to throttle increase than without airflow divider assembly 160. Preferably, divider 162 is slightly offset from center towards opening 198, as shown.

As stated above and shown, divider 162 preferably comprises aperture 174 that provides additional draw of airflow into the most open chamber, chamber 164 or chamber 166 during operation of the air regulator in response to throttle commands by a user. Further, the air is drawn through aperture 174 from the pressure differential on either side of divider 162. Upon reading the teachings of this specification, those with ordinary skill in the art will now understand that, under appropriate circumstances, considering such issues as economics, user preference, air conduit size, etc., other aperture arrangements, such as multiple apertures, larger or smaller apertures, etc., may suffice.

FIG. 17 shows a front view of another airflow divider assembly 220 of the air management system 100 according to another preferred embodiment of the present invention. FIG. 17 shows a removable bolt-on airflow divider assembly 220 (at least embodying herein at least one airflow director to direct the at least one flow of air within the at least one air conduit) according to a preferred embodiment of the present invention. Preferably, bolt-on airflow divider assembly 220 comprises collar 222, preferably comprising bolt apertures 228 and 230 (not shown). Preferably, the bolt-on airflow divider assembly 220 comprises divider 224 to direct the air, as described above, in an air inlet conduit. Preferably, divider 224 (at least embodying herein at least one divider adapted to divide at least one portion of the at least one air conduit into at least one first airflow channel and at least one second airflow channel) comprises aperture 250 (at least embodying herein at least one air pressure equalizer adapted to assist air pressure equalizing between the at least one first airflow channel and the at least one second airflow channel), as shown. Preferably, each collar 222 is designed to attach adjacent a specific carburetor or throttle body air inlet conduit. Most preferably, for example, as used on a motorcycle carburetor, collar 222 provides an attachment portion 226 for an air filter as would normally be attached to the air inlet conduit directly (using a circular clamp). Preferably, bolt-on airflow divider assembly 220 is attached directly above and with the same diameter as the air inlet conduit to which bolt-on airflow divider assembly 220 is being attached. Upon reading the teachings of this specification, those with ordinary skill in the art will now understand that, under appropriate circumstances, considering such issues as economics, user preference, etc., other attachment arrangements, such as clip-on attachments, screw-on/twist-on attachments, etc., may suffice.

Upon reading the teachings of this specification, those of ordinary skill in the art will now appreciate that the prior disclosed preferred embodiments effectively and efficiently improve the fluid flow characteristics of air entering the fuel management system. More specifically, air management system 100 of the above-described embodiments generally function to control and modify the airflow upstream of the airflow regulating assemblies (e.g. slide-type air regulator 104 or butterfly-valve air regulator 154). The Applicant has determined that equally significant increases in performance are possible by managing the airflow directly downstream from the airflow regulating assemblies.

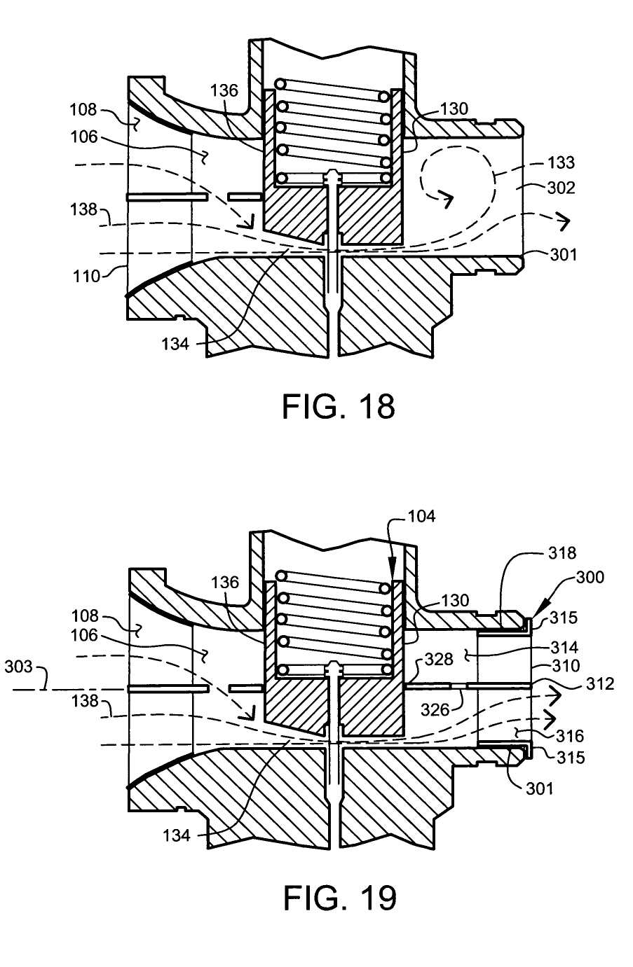

FIG. 18 is a sectional view diagrammatically illustrating the air inlet conduit of the slide-type air regulator of FIG. 6 at low throttle. As described in FIG. 6, placement of airflow divider assembly 110 at the intake side of air intake conduit 106, adjacent the opening 108, effectively manages the incoming flow of air such that there is little or no turbulent air generated within the area of air intake conduit 106 proceeding of slide valve 130, as shown. This arrangement permits an improved throttle response and measurably increased torque at key points within the power-band of essentially all internal combustion engines utilizing carburetion fuel systems. The Applicant has also determined that additional improvement to overall performance can be achieved by placing a posterior airflow divider assembly downstream of slide valve 130.

During low-throttle operation, as illustrated in FIG. 18, free-flowing air 138 quickly passes under slide valve 130, and immediately enters an area of increased volume 302, producing a region of turbulent air 133, as shown. The generation of turbulent air 133, within air intake conduit 106, results in a disruption of free-flowing air 138 passing through air intake conduit 106, as shown.

FIG. 19 is a sectional view diagrammatically illustrating air inlet conduit 106 of slide-type motorcycle carburetor 102, at low throttle, utilizing a pair of air management systems, according to another preferred embodiment of the present invention. Preferably, slide-type motorcycle carburetor 102 additionally comprises posterior air management system 300 (at least embodying herein at least one second airflow director to direct the at least one flow of air within the at least one air conduit) comprises airflow divider assembly 310 that inserts into the outlet end 301 of air inlet conduit 106 downstream of the air regulator (in this embodiment, the slide valve 130), as shown. Preferably, airflow divider assembly 310 is removably mounted within outlet end 301 of the air inlet conduit 106, as shown. Applicant's understanding of the theory of operation is that, in operation, posterior air management system 300 permits an increase in engine performance by greatly reducing or eliminating the generation of turbulent air 133 behind (downstream of) slide valve 130, as shown.

Preferably, the airflow divider assembly 310 comprises a substantially flat divider 312, preferably mounted essentially parallel to the longitudinal axis 303 of air inlet conduit 106, as shown. Preferably, divider 312 is approximately centered within and essentially spans the full diameter of outlet end 301, as shown. Preferably, divider 312 (at least embodying herein at least one second divider) divides air inlet conduit 106 into two additional airflow passages identified as chamber 314 and chamber 316, as shown (at least embodying herein at least one third airflow channel and at least one fourth airflow channel). Most preferably, in use with a slide-valve motorcycle carburetor 102, divider 312 separates a portion of air inlet conduit 106 into two essentially equal volumes (chamber 314 and chamber 316), as shown (at least embodying herein wherein the at least one third airflow channel and the at least one fourth airflow channel comprise essentially equal volumes). Upon reading the teachings of this specification, those with ordinary skill in the art will now understand that, under appropriate circumstances, considering such issues as economics, user preference, air inlet opening shape, air regulator (i.e. butterfly valve, sliding valve), etc., other placement locations for a divider, such as offset from center, slightly angled, etc., may suffice.

Preferably, the airflow divider assembly 310 further comprises divider supporter 318, adapted to firmly support divider 312 within air intake conduit 106, as shown. Preferably, divider supporter 318 is formed to closely fit within the interior peripheral profile of air inlet conduit 106, and is sized to be just slightly smaller than the inner diameter of the air inlet conduit 106, as shown (at least embodying herein wherein such at least one fixed positioner comprises at least one peripheral profile substantially matching such at least one interior peripheral profile of the at least one air conduit). In the example of FIG. 19, divider supporter 318 (at least embodying herein at least one second fixed positioner to assist fixed positioning of such at least one second airflow director in at least one geometric relationship with the at least one air conduit) comprises a hollow cylindrical conduit having peripheral flange 315 at one end, as shown. Preferably, peripheral flange 315 is adapted to maintain posterior air management system 300 in a proper operating position within outlet end 301 of the air inlet conduit 106, as shown.

In preferred embodiments of the present invention, divider 312 comprises air pressure equalizing aperture 326, comprising a round hole, preferably having a diameter of between about 0.200 inches and about 0.300 inches, preferably about 0.250 inches for the presently illustrated air conduit (a Mikuni 38 mm slide-carburetor). Upon reading the teachings of this specification, those with ordinary skill in the art will now understand that, under appropriate circumstances, considering such issues as economics, user preference, air conduit size, etc., other aperture arrangements, such as multiple apertures, larger or smaller apertures, slotted apertures, etc., may suffice.

Preferably, the center of aperture 326 is about six-tenths of an inch from edge 328 of the divider 112, as shown. Upon reading the teachings of this specification, those with ordinary skill in the art will now understand that, under appropriate circumstances, considering such issues as economics, user preference, aperture size, etc., other dimensions for apertures, such as closer or farther from an edge, etc., may suffice.

In other preferred embodiments, divider 312 is solid and does not require an air pressure-equalizing aperture (see for example FIG. 24 below). In both apertured and non-apertured embodiments, edge 328 of divider 312 is positioned closely adjacent slide valve 130 of air regulator 104, preferably less than about sixty-thousandths of an inch between them, as shown. Preferably, edge 328 of divider 312 is positioned closely adjacent slide valve 130 of air regulator 104 such that no contact occurs during movement of slide valve 130.

The applicant has observed measurable gas-flow increases, through air intake conduits containing only posterior air management system 300 (as further discussed in FIG. 26 below). The use of a primary air management system in conjunction with posterior air management system 300 within an internal combustion engine generally permits an improved throttle response and measurably increased torque at key points within an engine's power-band.

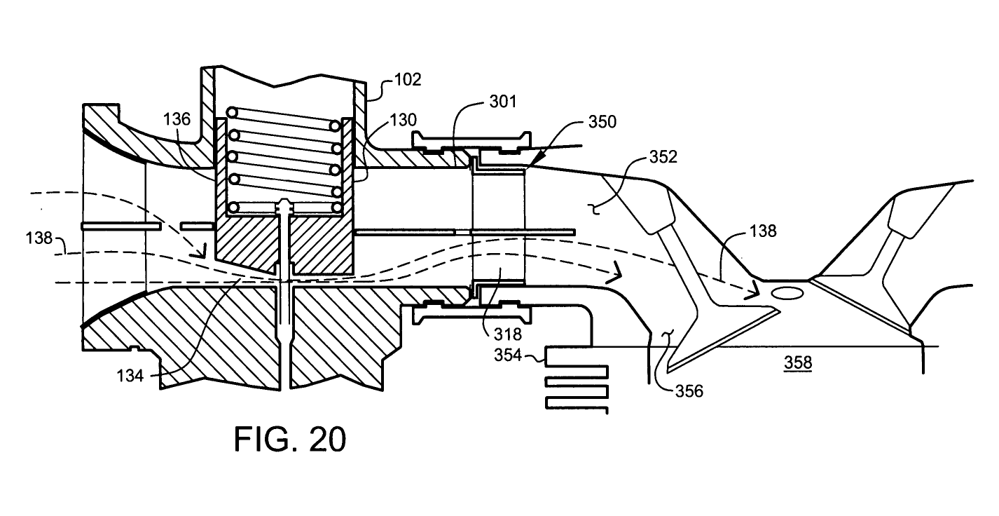

FIG. 20 is a diagrammatic sectional view illustrating the air inlet conduit of slide-type motorcycle carburetor 102, at low throttle, utilizing a pair of air management systems preferably comprising posterior air management systems 350, according to another preferred embodiment of the present invention. In specific engine configurations, it is preferred to position posterior air management system 350 (at least embodying herein at least one second airflow director to direct the at least one flow of air within the at least one air conduit) within intake passage 352 of engine head 354 (or intake manifold), adjacent outlet end 301 of slide-type motorcycle carburetor 102, as shown. In the example of FIG. 20, divider supporter 318 is preferably adapted to fit within intake passage 352 with peripheral flange 315 fitting adjacent outlet end 301 of motorcycle carburetor 102 and engine head 354, as shown. Under appropriate circumstances, divider 312 may preferably extend beyond divider supporter 318 to interior of intake passage 352 thus further assisting in directing free-flowing air 138 toward intake port 356 and combustion cylinder 358, as shown. Preferably, as required to best enhance engine performance, divider 312 may be non-appertured or apertured, as shown.

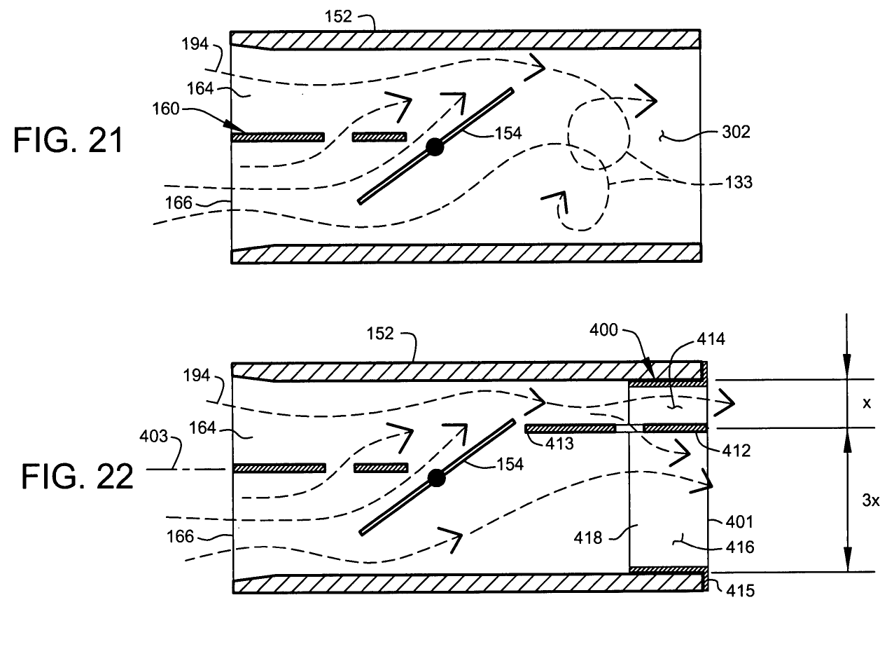

FIG. 21 shows a diagrammatic representation of air inlet conduit 152 and butterfly valve air regulator 154 in a low throttle position, with airflow divider assembly 160 of air management system 100 installed according to the preferred embodiment of FIG. 12. It is noted that the air inlet conduit 152 is generally descriptive of air regulating devices similar to the throttle-body 150 of FIG. 10.

As previously described in FIG. 15 and FIG. 16, placement of airflow divider assembly 160 at the intake side of air inlet conduit 152, effectively manages the incoming flow of air such that there is little or no turbulent air generated within the area of air intake conduit 152 proceeding the butterfly valve air regulator 154, as shown. This preferred arrangement permits an improved throttle response and measurably increased torque at key points within the power-band of essentially all internal combustion engines utilizing butterfly valve controlled fuel systems.

During open-throttle operation, as illustrated in FIG. 21, free-flowing air 194 quickly passes over and under butterfly-valve air regulator 154, and immediately enters an area of increased volume 302 within air intake conduit 152, as shown. Various throttle positions have an increased tendency to generate regions of turbulent air 133 behind (downstream of) butterfly valve air regulator 154, as shown. The generation of turbulent air 133, within air inlet conduit 152, results in a disruption of free-flowing air 194 passing through air inlet conduit 152, as shown.

FIG. 22 shows a diagrammatic representation of air inlet conduit 152 and butterfly valve air regulator 154 in a low throttle position, with airflow divider assembly 160 of air management system 100 installed according to a preferred embodiment of FIG. 12, and further utilizing posterior airflow divider assembly 400 installed downstream of butterfly valve air regulator 154, as shown. Preferably, posterior airflow divider assembly 400 (at least embodying herein at least one second airflow director to direct the at least one flow of air within the at least one air conduit) is installed into outlet end 401 of air inlet conduit 152 downstream of butterfly valve air regulator 154, as shown. Preferably, posterior airflow divider assembly 400 is removably mounted within outlet end 401 of the air inlet conduit 152, as shown. Applicant's understanding of the theory of operation is that, in operation, posterior airflow divider assembly 400 permits an increase in engine performance by greatly reducing or eliminating the generation of turbulent air 133 behind butterfly valve air regulator 154, as shown.

Preferably, posterior airflow divider assembly 400 comprises a substantially flat divider 412, preferably mounted essentially parallel to longitudinal axis 403 of air inlet conduit 152, as shown. Preferably, divider 412 divides air inlet conduit 152 into two additional airflow channels, chamber 414 and chamber 416, as shown (at least embodying herein at least one second divider adapted to divide at least one second portion of the at least one air conduit into at least one third airflow channel and at least one fourth airflow channel). Most preferably, in use with butterfly valve air regulator 154, divider 412 divides air inlet conduit 152 into chamber 414 and chamber 416 having two unequal volumes, as shown. Preferably, the volumetric ratio between chamber 416 and chamber 414 is about three to one (as generally defined by a length portion within air inlet conduit 152 approximately equaling the length of the divider 412). Upon reading the teachings of this specification, those with ordinary skill in the art will now understand that, under appropriate circumstances, considering such issues as economics, user preference, air inlet opening shape, air regulator (i.e. butterfly valve, sliding valve), etc., other placement locations for a divider, such as centered, slightly angled, etc., may suffice. Preferably, leading edge 413 of divider 412 is positioned to be in relatively close proximity to the butterfly valve air regulator 154 during low throttle operation, as shown.

Preferably, the posterior airflow divider assembly 400 further comprises divider supporter 418, adapted to firmly support divider 412 within air inlet conduit 152, as shown. Preferably, divider supporter 418 is formed to closely fit within the interior of air inlet conduit 152, and is sized to be just slightly smaller than the inner diameter of air inlet conduit 152, as shown. Preferably, divider supporter 418 positions divider 412 in a fixed geometric relationship with air inlet conduit 152 (at least embodying herein wherein such at least one airflow director comprises at least one fixed positioner to assist fixed positioning of such at least one airflow director in at least one geometric relationship with the at least one air conduit). In the example of FIG. 22, divider supporter 418 comprises a hollow cylindrical conduit having peripheral flange 415 at one end, as shown. Preferably, peripheral flange 415 is adapted to maintain posterior air management system 400 in a proper operating position within outlet end 401 of the air inlet conduit 152, as shown.

In preferred embodiments of the present invention, the divider 412 comprises air pressure equalizing aperture 426 (at least embodying herein at least one air pressure equalizer adapted to assist air pressure equalizing between the at least one first airflow channel and the at least one second airflow channel), comprising a round hole, preferably having a diameter of between about 0.200 inches and about 0.300 inches, as shown. Upon reading the teachings of this specification, those with ordinary skill in the art will now understand that, under appropriate circumstances, considering such issues as economics, user preference, preferred specific requirements of the user, etc., other sized apertures, such as larger or smaller, etc., may suffice. Furthermore, upon reading the teachings of this specification, those with ordinary skill in the art will now understand that, under appropriate circumstances, considering such issues as economics, user preference, air conduit size, etc., other aperture arrangements, such as multiple apertures, no apertures, larger or smaller apertures, slotted apertures, etc., may suffice.

Preferably, the center of aperture 426 is located about six-tenths of an inch from leading edge 413 of divider 412, as shown. Upon reading the teachings of this specification, those with ordinary skill in the art will now understand that, under appropriate circumstances, considering such issues as economics, user preference, aperture size, etc., other dimensions for aperture 426, such as closer or farther from leading edge 413, etc., may suffice.

In other preferred embodiments, divider 412 is solid and does not comprise an air pressure-equalizing aperture (see for example FIG. 24 below).

The applicant has observed measurable gas-flow increases, through air intake conduits containing only posterior air management system 400. Use of posterior air management system 400 within an internal combustion engine generally permits an improved throttle response and measurably increased torque at key points within the engine's power-band.

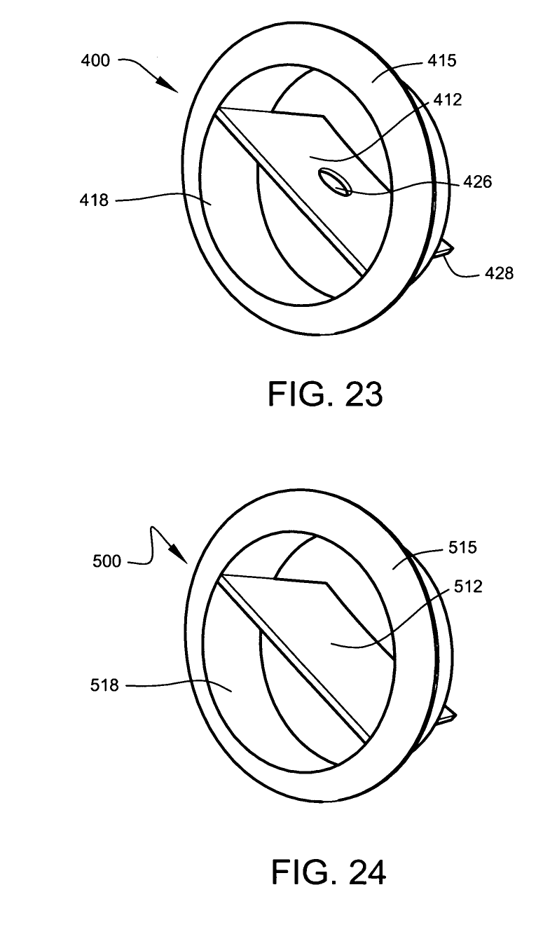

FIG. 23 is a perspective view of pressure equalizing posterior air management system 400 according to the preferred embodiment of FIG. 22. The preferred embodiment of FIG. 23 is also generally representative of the structures and arrangements of posterior air management system 300 and posterior air management system 350. Visible in FIG. 23 is divider 412, divider supporter 418, peripheral flange 415 and aperture 426. Aperture 426 preferably comprises a round hole, preferably having a diameter of between about 0.200 inches and about 0.300 inches, preferably about 0.250 inches for the air conduit (a Mikuni 38 mm slide-carburetor) shown in FIG. 1. Upon reading the teachings of this specification, those with ordinary skill in the art will now understand that, under appropriate circumstances, considering such issues as economics, user preference, air conduit size, etc., other aperture arrangements, such as multiple apertures, larger or smaller apertures, slotted apertures, etc., may suffice.

FIG. 24 is a perspective view of a non-pressure equalizing posterior air management system 500 (at least embodying herein at least one airflow director to direct the at least one flow of air within the at least one air conduit) according to another preferred embodiment of the present invention. Visible in FIG. 24 is the divider 512, divider supporter 518 and peripheral flange 515. Preferably, divider 512 (at least embodying herein at least one divider adapted to divide at least one portion of the at least one air conduit into at least one first airflow channel and at least one second airflow channel) is constructed without a pressure-equalizing aperture, as shown. It is noted that the use of solid dividers (those having no pressure equalizing aperture) are preferably adapted to installations downstream of the air-regulating valve.

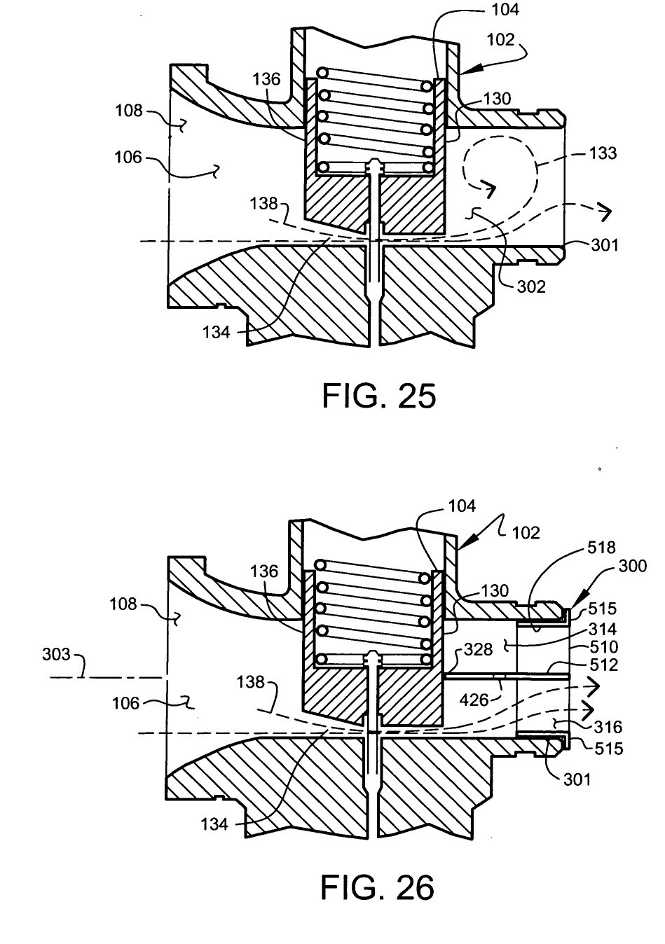

FIG. 25 is a sectional view diagrammatically illustrating the air inlet conduit of motorcycle carburetor 102 of FIG. 1 at low throttle. During low-throttle operation, the free-flowing air 138 quickly passes under the slide valve 130, and immediately enters an area of increased volume 302, thus producing a region of turbulent air 133, as shown. The generation of turbulent air 133, within the air intake conduit 106, results in a disruption of the free-flowing air 138 passing through the air intake conduit 106, as shown.

FIG. 26 is a sectional view diagrammatically illustrating the air inlet conduit of the motorcycle carburetor 102, at low throttle, utilizing only posterior air management system 500, according to the preferred embodiment of FIG. 24.

Preferably, the posterior air management system 500 comprises airflow divider assembly 510 that inserts into outlet end 301 of air inlet conduit 106 downstream of slide-type air regulator 104 (in this embodiment, slide valve 130), as shown. Preferably, airflow divider assembly 510 is removably mounted within outlet end 301 of air inlet conduit 106, as shown. Posterior air management system 500 permits an increase in engine performance by greatly reducing or eliminating the generation of turbulent air 133 behind (downstream of) slide valve 130, as shown.

Preferably, airflow divider assembly 510 comprises a substantially flat divider 512, preferably mounted essentially parallel to the longitudinal axis 303 of air inlet conduit 106, as shown. Preferably, divider 512 is centered within and essentially spans the full diameter of outlet end 301, as shown. Preferably, divider 512 divides air inlet conduit 106 into two airflow passages, chamber 314 and chamber 316, as shown. Most preferably, in use with slide-valve air regulator 104, divider 512 separates air inlet conduit 106 into two airflow passages of essentially equal volume, as shown. Upon reading the teachings of this specification, those with ordinary skill in the art will now understand that, under appropriate circumstances, considering such issues as economics, user preference, air inlet opening shape, air regulator (i.e. butterfly valve, sliding valve), etc., other placement locations for the divider, such as offset from center, slightly angled, etc., may suffice.

Preferably, airflow divider assembly 510 further comprises a divider supporter 518, adapted to firmly support divider 512 within air intake conduit 106, as shown. Preferably, divider supporter 518 is formed to closely fit within the interior peripheral profile of air inlet conduit 106, in the present example, sized to be just slightly smaller than the inner diameter of air inlet conduit 106, as shown (at least embodying herein wherein such at least one fixed positioner comprises at least one peripheral profile substantially matching such at least one interior peripheral profile of the at least one air conduit). In the example of FIG. 26, divider supporter 518 comprises a hollow cylindrical conduit having peripheral flange 515 at one end, as shown. Preferably, peripheral flange 515 is adapted to maintain posterior air management system 500 in a proper operating position within outlet end 301 of air inlet conduit 106, as shown.

Preferably, divider 512 is supplied without a pressure-equalizing aperture however, it should be noted that, in preferred applications of the present invention, divider 512 preferably comprises air pressure equalizing aperture 426 as illustrated in the posterior air management system 400 of FIG. 23.

Measurable gas-flow increases, through air intake conduits containing only the posterior air management system 400 or the posterior air management system 500 (as further described below), have been recorded. The use of a primary air management system in conjunction with posterior air management system 300, within internal combustion engines, generally permits an improved throttle response and measurably increased torque at key points within the engine's power-band.

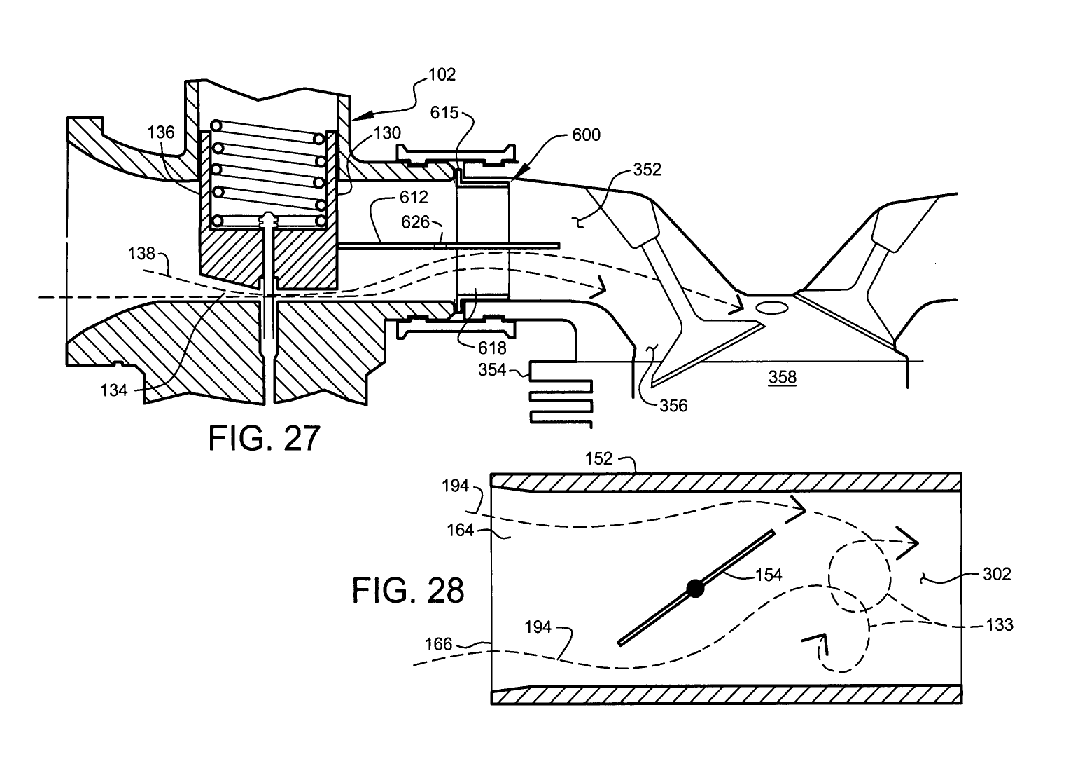

FIG. 27 is a sectional view diagrammatically illustrating the air inlet conduit of slide-type motorcycle carburetor 102, at low throttle, utilizing only the posterior air management system 600, according to another preferred embodiment of the present invention. In specific engine configurations, it is preferred to position posterior air management system 600 (at least embodying herein at least one airflow director to direct the at least one flow of air within the at least one air conduit) within intake passage 352 of engine head 354 (or intake manifold), as shown. In the example of FIG. 27, divider supporter 618 is preferably adapted to fit within the intake passage 352 with peripheral flange 615 fitting adjacent motorcycle carburetor 102 and engine head 354, as shown. Under appropriate circumstances, divider 612 may preferably extend beyond divider supporter 618 to interior of intake passage 352 thus further assisting in directing free-flowing air 138 toward the intake port 356 and combustion cylinder 358, as shown. Preferably, as required to best enhance engine performance, divider 612(at least embodying herein at least one divider adapted to divide at least one portion of the at least one air conduit into at least one first airflow channel and at least one second airflow channel) may be essentially solid (without an aperture) or may comprise pressure-equaling aperture 626, as shown.

Preferably, each configuration of the air management systems is adapted to match the engine size and performance output of the vehicle application. Preferably, each embodiment of the air management system is developed through physical testing of the actual vehicles to which the system will be installed and operated. Adaptations such as pressure equalizing apertures, materials, divider positions, etc. are selected based on measured flow/performance enhancement for each specific application.

FIG. 28 shows a diagrammatic representation of the air inlet conduit and butterfly valve air regulator in a low throttle position, with the airflow divider assembly of the air management system installed downstream of the butterfly valve, according to a preferred embodiment of the present invention. During open-throttle operation, as illustrated in FIG. 28, free-flowing air 194 quickly passes over and under butterfly-valve air regulator 154, and immediately enters an area of increased volume 302 within air intake conduit 152, as shown. Various throttle positions have an increased tendency to generate a region of turbulent air 133 behind (downstream of) butterfly valve air regulator 154, as shown. The generation of turbulent air 133, within air inlet conduit 152, results in a disruption of free-flowing air 194 passing through air inlet conduit 152, as shown.

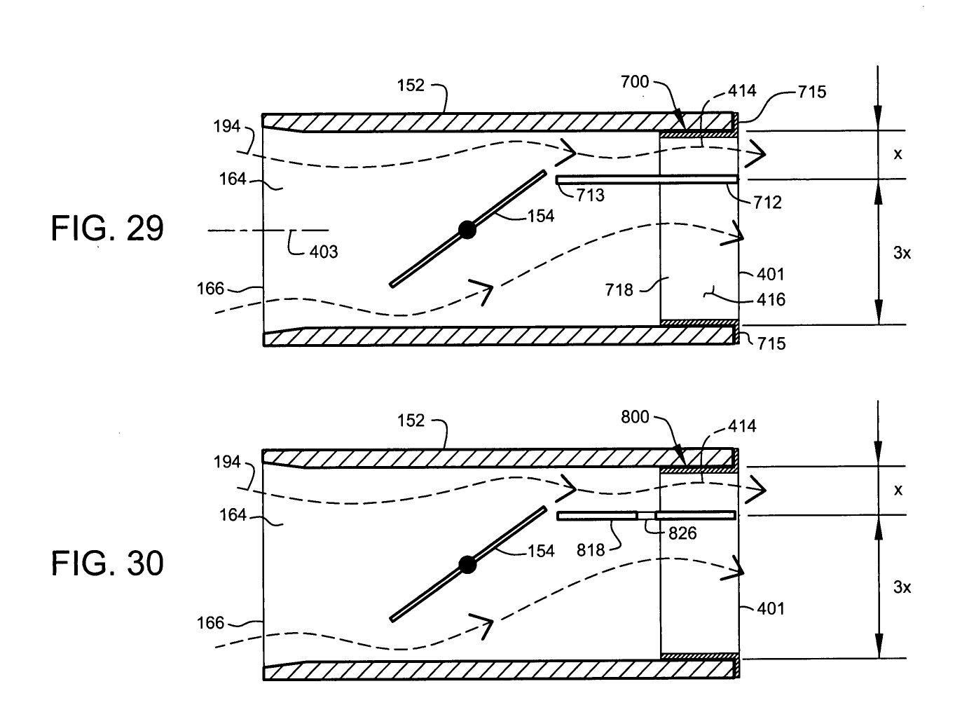

FIG. 29 shows a diagrammatic representation of air inlet conduit and butterfly valve air regulator, with a single posterior airflow divider assembly 700 installed downstream of the butterfly valve air regulator, according to another preferred embodiment of the present invention. Preferably, the posterior airflow divider assembly 700 (at least embodying herein at least one airflow director to direct the at least one flow of air within the at least one air conduit) is installed into outlet end 401 of air inlet conduit 152 downstream of the butterfly valve air regulator 154, as shown. Preferably, the posterior airflow divider assembly 700 is removably mounted within outlet end 401 of the air inlet conduit 152, as shown. In operation, posterior airflow divider assembly 700 permits an increase in engine performance by greatly reducing or eliminating the generation of turbulent air 133 behind butterfly valve air regulator 154, as shown.

Preferably, posterior airflow divider assembly 700 comprises a substantially flat divider 712, preferably mounted essentially parallel to longitudinal axis 403 of air inlet conduit 152, as shown. Preferably, divider 712 divides air inlet conduit 152 into two distinct airflow channels, chamber 414 and chamber 416, as shown. Most preferably, in use with butterfly valve air regulator 154, divider 412 divides air inlet conduit 152 into chamber 414 and chamber 416, preferably comprising two unequal volumes, as shown. Preferably, the volumetric ratio between chamber 416 and chamber 414 is about three to one (as generally defined by a portion within the air inlet conduit 152 approximately equaling the length of divider 712). Upon reading the teachings of this specification, those with ordinary skill in the art will now understand that, under appropriate circumstances, considering such issues as economics, user preference, air inlet opening shape, air regulator (i.e. butterfly valve, sliding valve), etc., other placement locations for a divider, such as centered, slightly angled, etc., may suffice. Preferably, leading edge 713 of divider 712 is positioned to be in relatively close proximity to butterfly valve air regulator 154 during low throttle operation, as shown.

Preferably, posterior airflow divider assembly 700 further comprises divider supporter 718, adapted to firmly support divider 712 within air inlet conduit 152, as shown. Preferably, divider supporter 718 is formed to closely fit within the interior peripheral profile of air inlet conduit 152, and is sized to be just slightly smaller than the inner diameter of the air inlet conduit 152, as shown (at least embodying herein wherein such at least one fixed positioner comprises at least one peripheral profile substantially matching such at least one interior peripheral profile of the at least one air conduit). In the example of FIG. 29, divider supporter 718 comprises a hollow cylindrical conduit having peripheral flange 715 at one end, as shown. Preferably, peripheral flange 715 is adapted to maintain posterior air management system 700 in a proper operating position within outlet end 401 of air inlet conduit 152, as shown.

The applicant has observed measurable gas-flow increases, through air intake conduits containing only posterior air management system 700. Use of posterior air management system 700 within an internal combustion engine generally permits an improved throttle response and measurably increased torque at key points within the engine's power-band.

FIG. 30 shows a diagrammatic representation of the air inlet conduit and butterfly valve air regulator, with an aperture containing posterior airflow divider assembly 800 installed downstream of the butterfly valve air regulator 154, according to another preferred embodiment of the present invention. Preferably, posterior airflow divider assembly 800 matches the design of construction of posterior airflow divider assembly 700 of FIG. 29, as shown. In addition, divider 818 (at least embodying herein at least one divider adapted to divide at least one portion of the at least one air conduit into at least one first airflow channel and at least one second airflow channel) of posterior airflow divider assembly 800 comprises pressure-equalizing aperture 826 (at least embodying herein at least one air pressure equalizer adapted to assist air pressure equalizing between the at least one first airflow channel and the at least one second airflow channel), as shown. The apertured posterior airflow divider assembly 800 is preferably, used to enhance the performance of specific internal combustion engines applications. As previously indicated, each configuration of the air management systems is adapted to match the engine size and performance output of the vehicle application. Preferably, each embodiment of the air management system is developed through physical testing of the actual vehicles to which the system will be installed and operated. Adaptations, such as the use of pressure equalizing apertures, materials divider positions, etc., are selected based on measured flow/performance enhancement for each specific application.

FIG. 31 is an exploded side view illustrating the use of a downstream posterior airflow divider assembly 900 in conjunction with the throttle body inlet air conduit of FIG. 10 and upstream air management system 1000, according to another preferred embodiment of the present invention. Preferably, posterior airflow divider assembly 900 (at least embodying herein at least one second airflow director to direct the at least one flow of air within the at least one air conduit) is adapted to fit downstream of butterfly-valve air regulator 154 (see FIG. 10) of throttle body 150, as shown. It should be noted that in preferred applications, posterior airflow divider assembly 900 is utilized as the only airflow divider assembly within the throttle body inlet air conduit.

In preferred applications of the present invention, the greatest performance increase is achieved by utilizing both the upstream air management system 1000 and posterior airflow divider assembly 900, as shown.

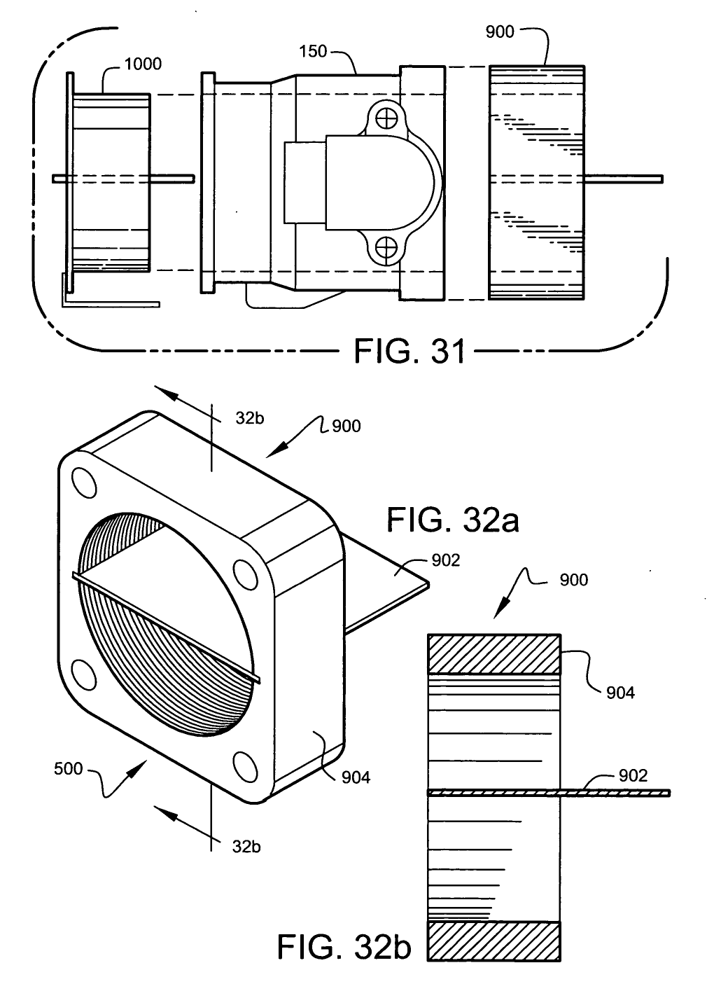

FIG. 32a shows a perspective view of the downstream posterior airflow divider assembly 900 of FIG. 32a. Preferably, posterior airflow divider assembly 900 comprises divider 902 permanently joined with divider supporter 904, as shown. Preferably, divider supporter 904 is adapted to be mounted adjacent to outlet of throttle body 150 using the original fastening spacing pattern of throttle body 150, as shown. Preferably, divider supporter 904 positions divider 902 in a fixed geometric relationship with the air conduit of throttle body 150 (at least embodying herein wherein such at least one airflow director comprises at least one fixed positioner to assist fixed positioning of such at least one airflow director in at least one geometric relationship with the at least one air conduit). Preferably, divider supporter 904 is cast and/or milled from aluminum. Preferably, divider 902 (at least embodying herein at least one second airflow director to direct the at least one flow of air within the at least one air conduit) comprises a rigid metallic material such as stainless steel. Upon reading the teachings of this specification, those with ordinary skill in the art will now understand that, under appropriate circumstances, considering issues such as, intended use, cost, etc., other material selections, such as, for example, titanium, plastics, composites, etc., may suffice.

FIG. 32b shows a sectional view through the section 32c-32c of FIG. 32a further illustrating the preferred arrangements of posterior airflow divider assembly 900. Preferably, as required to best enhance engine performance, divider 902 may comprise a pressure-equaling aperture, or may be essentially solid (without an aperture), as shown.

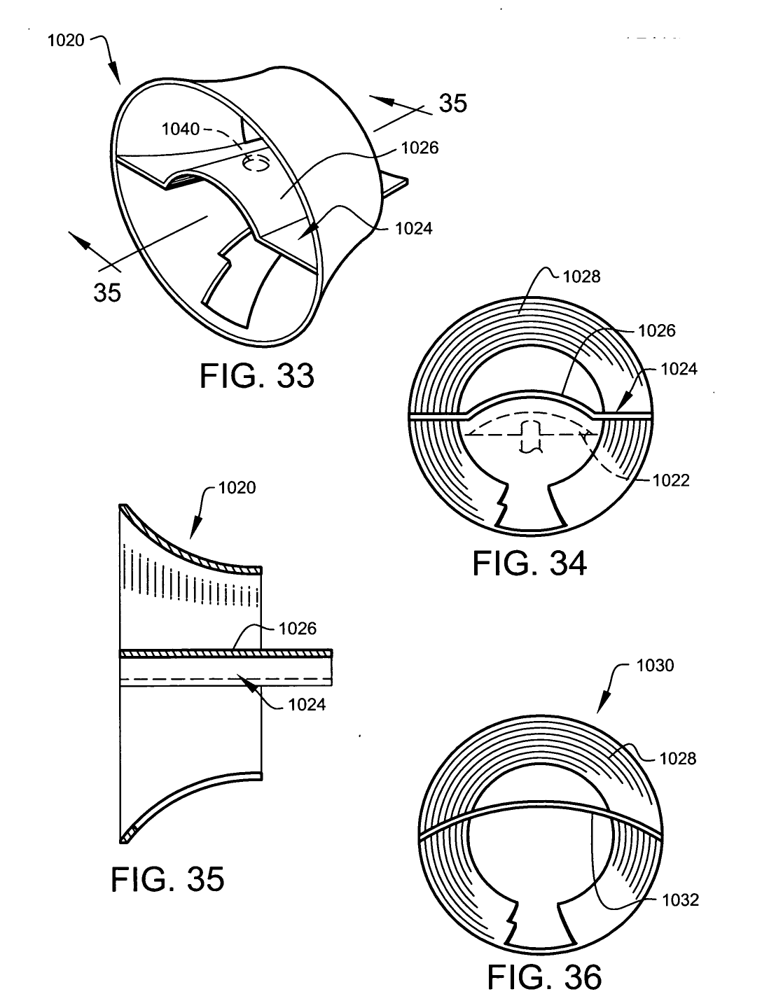

FIG. 33 shows shaped airflow divider assembly 1020 (at least embodying herein at least one airflow director to direct the at least one flow of air within the at least one air conduit) of air management system 100 according to a preferred embodiment of the present invention. In discussing the embodiment of FIG. 33, it is helpful to again refer to slide-type air regulator 104 of motorcycle carburetor 102 (as best illustrated in FIG. 3). Typically, the airbox side of slide-type air regulator 104 comprises a shaped portion known as a cutaway (hereinafter referred to as cutaway 1022). In a typical slide-type carburetor, the size of cutaway 1022 affects the air-fuel mixture ratio when the throttle valve opening is between ⅛ to ½ throttle, especially in the range of ⅛ to ¼ throttle. Often an alteration in the size of cutaway 1022 is used to tune the carburetor for optimum performance. Typically, an increase in the size of cutaway 1022 reduces airflow resistance, causing the amount of air intake to increase, thereby resulting in a leaner mixture. Conversely, the smaller the size of cutaway 1022, the richer air-fuel mixture will become.

Typically, cutaway 1022 is shaped to provide improved airflow dynamics through the air intake conduit 106 at all throttle positions. In example motorcycle carburetor 102, cutaway 1022 comprises an “arc” shape having a diameter approximating the interior size of air intake conduit 106, as shown.

Preferably, fin 1024 of shaped airflow divider assembly 1020 comprises shaped portion 1026, having a shape generally matching the proven aerodynamic conformation of cutaway 1022. Preferably, the dividing plane of fin 1024 is aerodynamically shaped such that portions of the fin extend beyond a single plane to direct airflow approaching slide-type air regulator 104. The aerodynamic shaping of fin 1024 preferably directs the incoming air stream such that there is reduced turbulence generated in front of slide-type air regulator 104, enabling a more consistent airflow through the carburetor. Furthermore, the complementary shape matching of fin 1024 and cutaway 1022 greatly enhances airflow dynamics, through air intake conduit 106, as the position of cutaway 1022 and fin 1024 align (for example, at approximately mid throttle). Upon reading the teachings of this specification, those with ordinary skill in the art will now understand that, under appropriate circumstances, considering such issues as advances in carburetor technology, vehicle use, etc., other fin shapes, such as configurations deviating from the shape of the cutaway, shapes reinforcing the flow dynamic at specific engine RPMs, etc., may suffice. It is optionally preferred, in some vehicle applications, to provide fin 1024 with at least one pressure-equalizing feature between the upper and lower chambers. More specifically, where flow testing indicates the need for pressure equalization, aperture 1040 is preferably provided within fin 1024, as shown in dashed lines (at least embodying herein at least one air pressure equalizer adapted to assist air pressure equalizing between the at least one first airflow channel and the at least one second airflow channel).

FIG. 34 shows an intake-end view of shaped airflow divider assembly 1020 of FIG. 33. Preferably, fin 1024 is positioned approximately along the midpoint of fin supporter 1028, as shown. Cutaway 1022 (illustrated in dashed lines) of airflow divider assembly 1020 is superimposed behind fin 1024 to show the preferred shape relationships of the present embodiment. Upon reading the teachings of this specification, those with ordinary skill in the art will now understand that, under appropriate circumstances, considering such issues as typical throttle position, intended use, etc., other fin shapes and positions within the fin supporter, such as higher, lower, skewed, asymmetrically aligned, etc., may suffice.

FIG. 35 shows a sectional view through the section 35-35 of FIG. 33. Preferably, material selection, assembly, and finishing of airflow divider assembly 1020 are essentially identical to the airflow divider embodiment of FIG. 2, through FIG. 9.

FIG. 36 shows an intake end view of shaped airflow divider assembly 1030 according to another preferred embodiment of the invention. The embodiment of FIG. 36 illustrates the adaptability of the shaped fin airflow divider to a wide range of sections and profiles. Preferably, shaped airflow divider assembly 1030 (at least embodying herein at least one airflow director to direct the at least one flow of air within the at least one air conduit) comprises fin 1032 having a single continuous arch-shape spanning the interior of fin supporter 1028, as shown. Upon reading the teachings of this specification, those with ordinary skill in the art will now understand that, under appropriate circumstances, considering such issues as dynamometer testing, user preference, etc., other fin arrangements, such as perforated fins, tapering of leading edges, use of anti-turbulence surface treatments, etc., may suffice.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

1) An air management system relating to directing at least one flow of air passing through at least one air conduit of at least one vehicle fuel system, the at least one air conduit comprising at least one airflow inlet, at least one airflow outlet, and at least one airflow regulator adapted to regulate the passage of the at least one flow of air from the at least one airflow inlet, to the at least one airflow outlet, said system comprising:
a) at least one airflow director to direct the at least one flow of air within the at least one air conduit;
b) wherein said at least one airflow director comprises at least one fixed positioner to assist fixed positioning of said at least one airflow director in at least one geometric relationship with the at least one air conduit;
c) wherein said at least one airflow director further comprises at least one divider adapted to divide at least one portion of the at least one air conduit into at least one first airflow channel and at least one second airflow channel; and
d) wherein said at least one airflow director further comprises at least one air pressure equalizer adapted to assist air pressure equalizing between the at least one first airflow channel and the at least one second airflow channel.

2) The air management system according to claim 1 wherein said at least one fixed positioner is adapted to be removably retained within the at least one portion of the at least one air conduit.

3) The air management system according to claim 1 wherein said at least one fixed positioner is adapted to be removably retained adjacent the at least one portion of the at least one air conduit.

4) The air management system according to claim 1 wherein:
a) the at least one air conduit comprises at least one interior peripheral profile; and
b) said at least one fixed positioner comprises at least one peripheral profile substantially matching such at least one interior peripheral profile of the at least one air conduit.

5) The air management system according to claim 1 wherein:
a) the at least one airflow regulator is disposed within the at least one air conduit between the at least one airflow inlet and the at least one airflow outlet; and
b) said at least one fixed positioner is adapted to be removably retained substantially within the at least one air conduit between the at least one airflow inlet and the at least one airflow regulator.

6) The air management system according to claim 1 wherein:
a) the at least one airflow regulator is disposed within the at least one air conduit between the at least one airflow inlet and the at least one airflow outlet; and
b) said at least one fixed positioner is adapted to be removably retained substantially within the at least one air conduit between the at least one airflow regulator and the at least one airflow outlet.

7) The air management system according to claim 1 wherein:
a) said at least one fixed positioner is adapted to be removably mounted adjacent the at least one airflow inlet.

8) The air management system according to claim 1 wherein:
a) said at least one fixed positioner is adapted to be removably mounted adjacent the at least one airflow outlet.

9) The air management system according to claim 1 wherein, within the at least one portion, the at least one first airflow channel and the at least one second airflow channel comprise essentially equal volumes.

10) The air management system according to claim 1 wherein, within the at least one portion, the at least one first airflow channel and the at least one second airflow channel comprise unequal volumes.

11) The air management system according to claim 10 wherein such unequal volumes comprise at least one volumetric relationship having a ratio of about three to one.

12) The air management system according to claim 1 further comprising such at least one vehicle fuel system.

13) The air management system according to claim 1 wherein said at least one divider comprises said at least one air pressure equalizer.

14) The air management system according to claim 13 wherein said at least one air pressure equalizer comprises at least one aperture adapted to provide fluid communication between the at least one first airflow channel and the at least one second airflow channel.

15) The air management system according to claim 14 wherein said at least one aperture comprises at least one essentially round hole.

16) The air management system according to claim 15 wherein said at least at least one essentially round hole has a diameter of between about one-sixteenth inch and about one-inch.

17) An air management system relating to directing at least one flow of air passing through at least one air conduit of at least one vehicle fuel system, the at least one air conduit comprising at least one airflow inlet, at least one airflow outlet, and at least one airflow regulator adapted to regulate the passage of the at least one flow of air from the at least one airflow inlet, to the at least one airflow outlet, said system comprising:
a) at least one airflow director to direct the at least one flow of air within the at least one air conduit;
b) wherein said at least one airflow director comprises at least one fixed positioner to assist fixed positioning of said at least one airflow director in at least one geometric relationship with the at least one air conduit;
c) wherein said at least one airflow director further comprises at least one divider adapted to divide at least one portion of the at least one air conduit into at least one first airflow channel and at least one second airflow channel; and
d) wherein said at least one fixed positioner is adapted to be removably retained adjacent the at least one airflow outlet.

18) The air management system according to claim 17 wherein said at least one fixed positioner is adapted to be removably retained substantially within the at least one air conduit between the at least one airflow regulator and the at least one airflow outlet.

19) The air management system according to claim 17 wherein:
a) the at least one air conduit comprises at least one interior peripheral profile; and
b) said at least one fixed positioner comprises at least one peripheral profile substantially matching such at least one interior peripheral profile of the at least one air conduit.

20) The air management system according to claim 17 further comprising:
a) at least one second airflow director to direct the at least one flow of air within the at least one air conduit;
b) wherein said at least one second airflow director comprises at least one second fixed positioner to assist fixed positioning of said at least one second airflow director in at least one geometric relationship with the at least one air conduit;
c) wherein said at least one second airflow director further comprises at least one second divider adapted to divide at least one second portion of the at least one air conduit into at least one third airflow channel and at least one fourth airflow channel; and
d) wherein said at least one second fixed positioner is further adapted to be removably retained adjacent the at least one airflow inlet.

21) The air management system according to claim 20 wherein said at least one second airflow director is adapted to be removably retained within the at least one air conduit between the at least one airflow inlet and the at least one airflow regulator.

22) The air management system according to claim 20 wherein, within the at least one second portion, the at least one third airflow channel and the at least one fourth airflow channel comprise essentially equal volumes.

23) The air management system according to claim 20 wherein, within the at least one second portion, the at least one third airflow channel and the at least one fourth airflow channel comprise unequal volumes.

24) The air management system according to claim 23 wherein such unequal volumes comprise at least one volumetric relationship having a ratio of about three to one.

25) The air management system according to claim 17 further comprising the at least one vehicle fuel system.

26) The air management system according to claim 20 further comprising the at least one vehicle fuel system.

27) The air management system according to claim 20 wherein at least one of said at least one divider and at least one second divider comprise at least one air pressure equalizer.

28) The air management system according to claim 27 wherein said at least one air pressure equalizer comprises at least one aperture.

29) The air management system according to claim 28 wherein said at least one aperture comprises at least one essentially round hole.

30) The air management system according to claim 29 wherein said at least at least one essentially round hole has a diameter of between about one-sixteenth inch and about one-inch.

31) An air management system relating to directing at least one flow of air passing through at least one air conduit of at least one vehicle fuel system, the at least one air conduit comprising at least one airflow inlet, at least one airflow outlet, and at least one airflow regulator adapted to regulate the passage of the at least one flow of air from the at least one airflow inlet, to the at least one airflow outlet, said system comprising:
a) at least one airflow director to direct the at least one flow of air within the at least one air conduit;
b) wherein said at least one airflow director comprises at least one fixed positioner to assist fixed positioning of said at least one airflow director in at least one geometric relationship with the at least one air conduit;
c) wherein said at least one airflow director further comprises at least one divider adapted to divide at least one portion of the at least one air conduit into at least one first airflow channel and at least one second airflow channel; and
d) wherein at least one divider portion of said at least one divider is located substantially outside of exactly one single plane.

32) The air management system according to claim 31 wherein said at least one divider portion comprises at least one arc.

33) The air management system according to claim 32 wherein:
a) the at least one airflow regulator comprises at least one throttle slide having at least one cutaway; and
b) said at least one arc is structured and arranged to assist improved air flow adjacent the at least one cutaway.

34) The air management system according to claim 33 wherein said at least one arc substantially matches in profile such at least one cutaway of such at least one throttle slide of the at least one vehicle fuel system.

35) The air management system according to claim 34 wherein said at least one airflow director comprises at least one air pressure equalizer adapted to assist air pressure equalizing between the at least one first airflow channel and the at least one second airflow channel.

36) The air management system according to claim 34 wherein:
a) the at least one air conduit comprises at least one interior peripheral profile; and
b) said at least one fixed positioner comprises at least one peripheral profile substantially matching such at least one interior peripheral profile of the at least one air conduit.
